(19) United States
(12) Patent Application Publication
(10) Pub. No.: US 2005/0210934 A1
(43) Pub. Date: Sep. 29, 2005

(54) Keyless latch for an anti-burglalry window

(76) Inventors: Hsiu-Hsiung Chao, Taichung City (TW); Ling-Hsien Chao, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 11/050,756

(22) Filed: Feb. 7, 2005

(30) Foreign Application Priority Data
Mar. 23, 2004 (TW) 093204426

(51) Int. Cl. E05B 65/08

(52) U.S. Cl. 70/90

(57) ABSTRACT

A keyless latch for an anti-burglary window is positioned between an anti-burglary net window body and an outer window body, including a swing plate for swinging in the inside of a room, a helical member engaging with the swing plate, which then engages with and moving a latch body to shift linearly. Then the latch body can accordingly extend in or out of a latch hole so as to lock or unlock the anti-burglary net window body without a key. Then the anti-burglary window can form a through space for persons inside the room to escape out thereof in case of emergency. The swing plate can be hidden and protected to prevent the glass of the inner or the outer window body from cut illegally. At the same time the swing plate is located inside and impossible to reach from the outside, even if the inner window body is opened, attaining the anti-burglary effect.

### BACKGROUND OF THE INVENTION

1. Field of the Invention

This invention relates to keyless latch for an anti-burglary window, particularly to one quickly locking or unlocking the latch on an anti-burglary net window body for safely protecting the window from illegal prying open by burglars and for persons inside to escape out in case of emergency, with the latch difficult to be unlocked from the outside,

2. Description of the Prior Art

A conventional anti-burglary window 10 shown in FIG. 1 includes a window frame 12 and two window bodies 11, a metal grid 14 fixed in the intermediate portion by a screw 13, a glass 15 placed at two sides (the inner window and the outer window) or at one side (the outer window) only and then secured by silicon gelatin added on its circumferential edge connected with the window frame 12, and a net window body 17 slidably provided at the outer side. The net window body 17 has an anti-burglary net window 18 slidably provided at the outer side of the net window body 17, with a lock 181 locking the window 10 with the sash frame 19.

However, if the two window bodies 11 of the conventional window 10 are opened, they can be pushed to the same side of the anti-burglary net window body 18, and then the anti-burglary function of the conventional anti-burglary window has been lost. Besides, if should happen any danger in the house, with the window bodies 11 and the anti-burglary net window 18 both locked, persons in the house have to unlock the latches for both the window bodies 11 and the net window bodies 18, delayed in escaping out, very dangerous.

### SUMMARY OF THE INVENTION

This invention has been devised to offer a keyless latch for an anti-burglary window, which is placed between an anti-burglary net window body and an outer window body, and a swing plate for locking and unlocking the latch in the inside of a room so as to open the inner window body and the outer window body for escaping out of the anti-burglary window in case of emergency. The keyless latch further includes a helical member engaging a latch body, and the latch body has its end facing the latch hole of the anti-burglary net window body to let the latch body move linearly by swinging the swing plate. Then the latch body timely extends in or shifts out of a latch hole of said anti-burglary net window body for locking or unlocking the anti-burglary net window body. Further, a protective plate is provided outside of the swing plate to hide it completely over the swinging area of the swing plate.

The keyless latch according to the invention can permit the anti-burglary net window body to be quickly locked or unlocked, attaining safety against burglary, protecting the glass from cut from outside by burglars to tamper with the swing plate to unlock the latch. Moreover, even if the inner window body is opened, the swing plate is still hidden between the inner and the outer window body, impossible to reach, quite effective for preventing burglary.

### BRIEF DESCRIPTION OF DRAWINGS

This invention will be better understood by referring to the accompanying drawings, wherein:

FIG. 1 is a cross-sectional view of a conventional anti-burglary window;

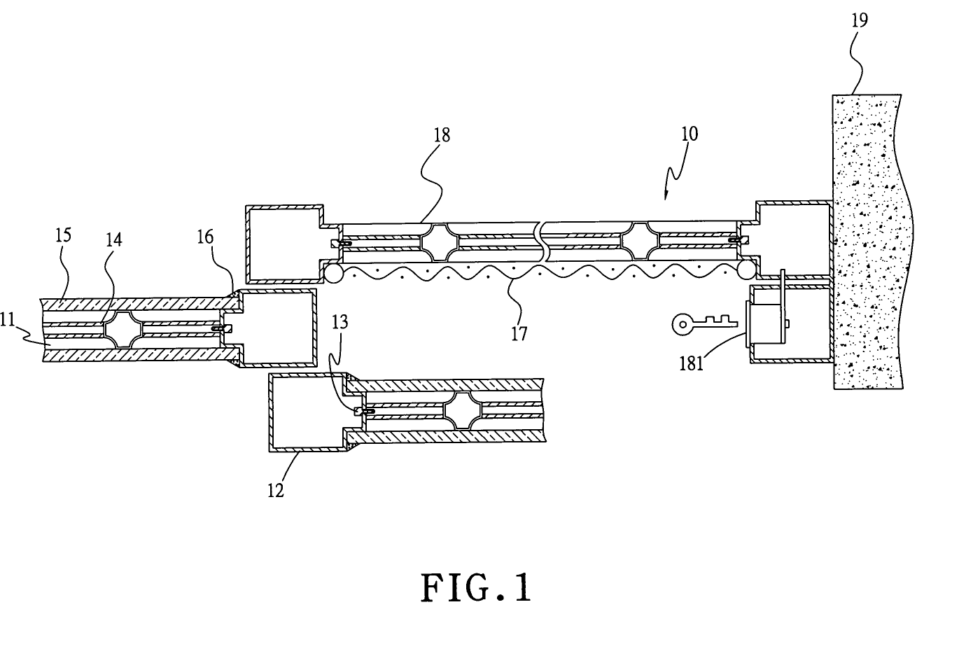

FIG. 2 is a cross-sectional view of an anti-burglary window with a keyless latch. In the present invention;

FIG. 3 is a perspective view of the keyless latch in the present invention;

FIG. 4 is an exploded perspective view of the keyless latch in the present invention;

FIG. 5 is a front view of the keyless latch being swung for latching in the present invention;

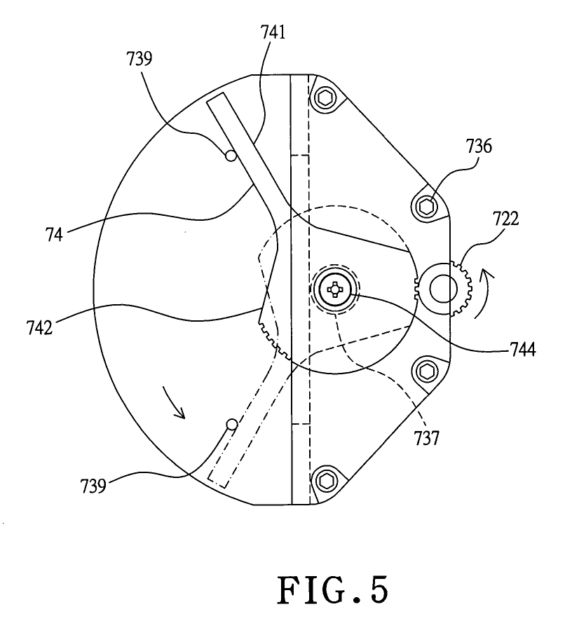

FIG. 6 is a partial cross-sectional view of the anti-burglary window with the keyless latch locked in the present invention;

FIG. 7 is a front view of the keyless latch being swung to unlock the locked condition in the present invention;

FIG. 8 is a partial cross-sectional view of the anti-burglary window with the latch unlocked in the present invention;

FIG. 9 is a cross-sectional view of the anti-burglary window with its inner window body and the anti-burglary net window body opened by unlocking the latch to form a large hollow space for escaping out in the present invention; and,

FIG. 10 a cross-sectional view of the anti-burglary window with only its inner window body opened and the latch still in the locked condition in the present invention.

### DETAILED DESCRIPTION OF THE PREFERRED EMBODIMENT

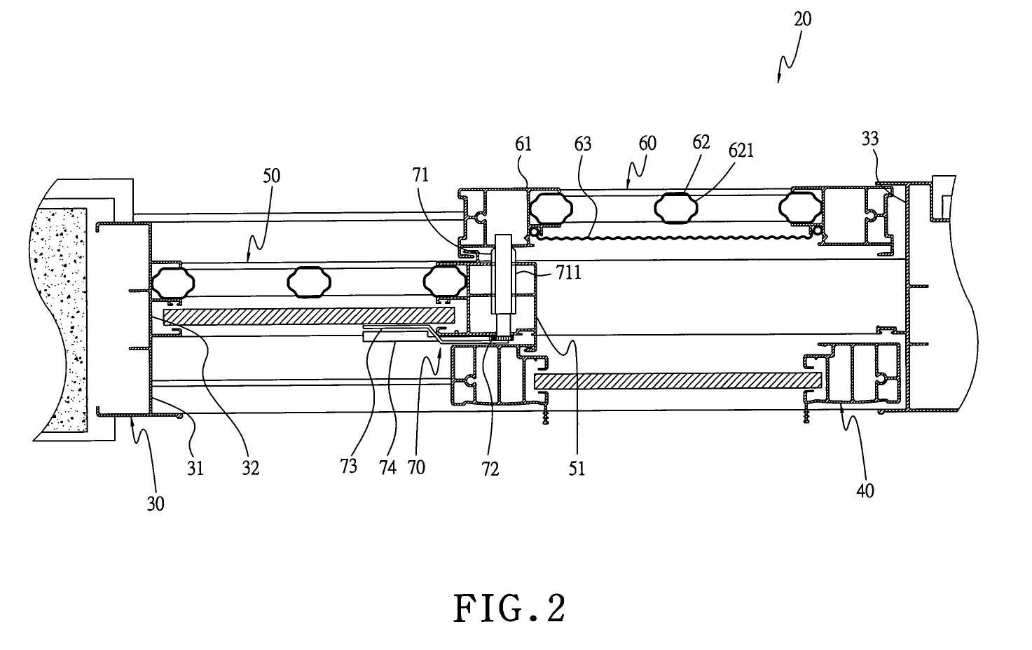

A preferred embodiment of a keyless latch 70 for an anti-burglary window 20 in the present invention, as shown in FIGS. 2, is installed in a sash frame 30 provided with an inner window groove 31, an outer window groove 32 and a net window groove 33 orderly from inside to outside. The anti-burglary window consists of an inner window body 40 provided with a slidable switch, the outer window body 50 provided with a fixed switch and the anti-burglary net window body 60 provided with a slidable switch. The anti-burglary net window body 60 has a four side frame 61, an anti-burglary layer 62 and a net 63 fixed inside the four side frame 61, and the anti-layer 62 is composed of a plural vertical steel tubes 621 spaced apart properly between the two vertical sides of the four-side frame 61. Further, the anti-burglary net window body 60 and the outer window body 40 are positioned at different sides.

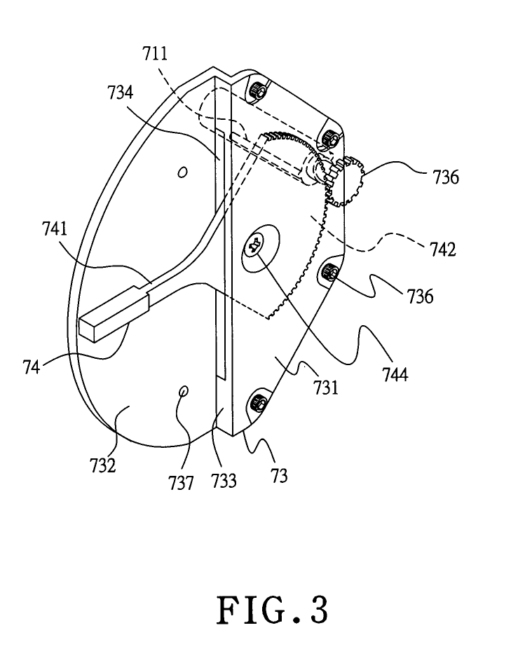

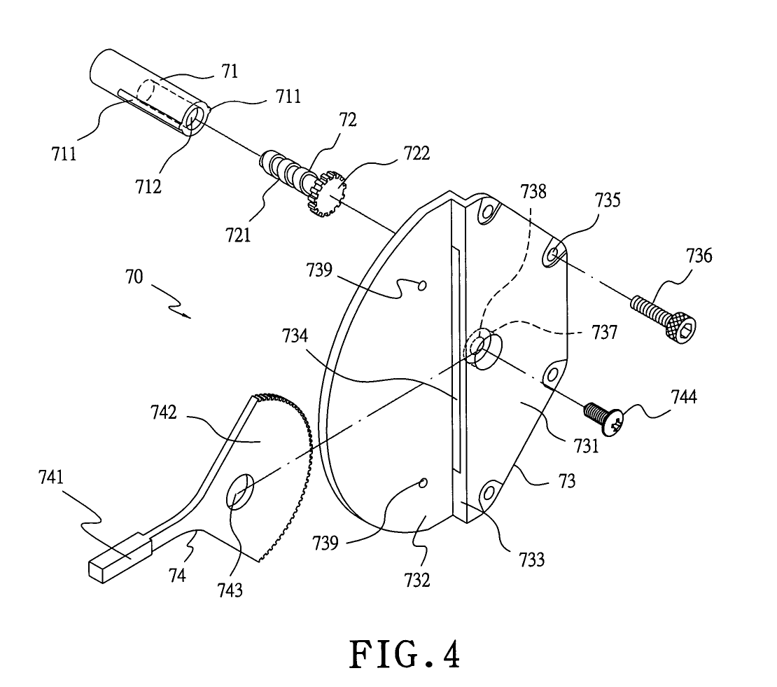

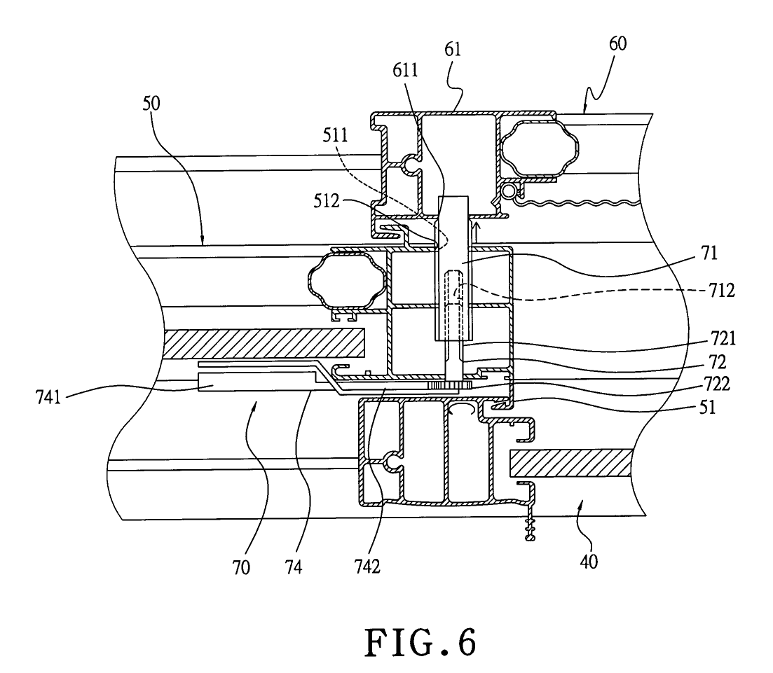

The latch 70 is positioned between the anti-burglary net window body 60 and a middle post 51 of the outer window body 50, as shown in FIGS. 3, 4 and 6, consisting of a latch body 71, a helical member 72, a protective plate 73 and a swing plate 74.

The outer window body 50 has its middle post 51 provided with a hole 511 through its inner wall and its outer wall, and a position groove 512 formed at two sides of the hole 511.

The anti-burglary net window body 60 has a frame 61 abutting on the outer window body 50, a latch hole 611 formed in an inner wall of the frame 61 facing the hole 511 of the middle post 51 of the outer window body 50.

The latch body 71 is post-shaped, having two symmetrical elongate position ridges 711 formed on its outer surface for the latch body 71 extensible in the hole 511 of the outer window body 50 and then fits in the two position grooves 512 of the hole 511 and secured stably in place so that the latch body 71 may be limited in its rotation. The latch body 71 further has a helical hole 712 formed in an inner side portion and its outer side portion facing to the latch hole 611 of the anti-burglary net window body 60, enabling the latch body 71 extend in and out therein.

The helical member 72 is provided with a helical rod member 721 and a gear 722 connected with an inner end of the helical rod member 721, possible to let the helical rod member 721 insert in the hole 511 of he outer window body 50. Then the helical rod member 721 engages the helical hole 712 of the latch body 71, with the gear 722 possible to be limited in its axial position. Then when the helical member 72 is rotated in a preset direction, the latch body 71 may be moved linearly in and out.

The protective plate 73 is shaped as a nearly round plate, consisting of a pivotal plate member 731 formed in the right side portion, and a stop plate member 732 formed in the left side portion. The pivotal plate member 731 is a little higher than the stop plate member 732, and an elongate ramp 733 defined between and connecting the pivotal plate member 731 and the stop plate member 732, and an elongate slot 734 is bored in the ramp 733. Further, the pivotal plate member 731 has plural holes 735 spaced apart around near its outer edge for bolts 736 to screw in and further engage with an inner wall of the middle post of the outer window body 50. Then the inner surface of the pivotal plate member 731 properly limits the inner wall of the gear 722. The pivotal plate member 731 further has an annular shaft tube 737 in the center and a hole 738 of a smaller diameter under the shaft tube 737, and the stop plate member 732 has a position projecting point 739 respectively on the upper and the lower surface.

The swing plate 74 consists of an elongate pull rod member 741 and a fan-shaped gear 742 formed at the inner end of the pull rod member 741. The fan-shaped gear 742 has a shaft hole 743 in the center portion, and just located between pivotal plate member 731 and the inner wall of the middle post 51 of the outer window body 50 after passing through the elongate slot 734, with the shaft hole 743 fitting around the shaft tube 737 of the pivotal plate member 731 and a bolt 744 passes through the hole 738 and further engages tightly with the inner wall of the middle post 51. Therefore, the fan-shaped gear 742 may engage with the gear 722 of the helical member 72. The pull rod member 741 passing through the slot 734 is located just on the inner surface of the stop plate member 732. As the total teeth number of the fan-shaped gear 742 is more that that of the gear 722, so when the pull rod member 741 is swung for a certain angle, the fan-shaped gear 742 is rotated with the bolt 744 as a shaft, at same time rotating the gear 722 accordingly, so as to indirectly shifting and locking or unlocking the latch body 71. Finally the pull rod member 741 may be stopped in place by the two stop projecting points 739 of the protective cover 73, and also be hidden by the protective plate 73 from the outside.

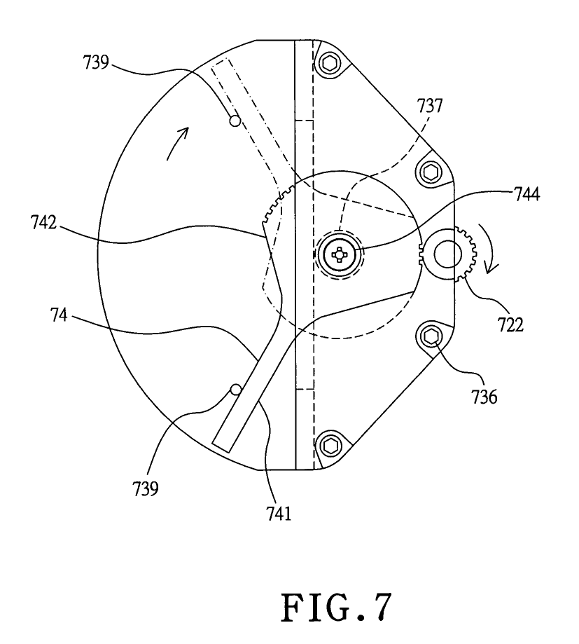

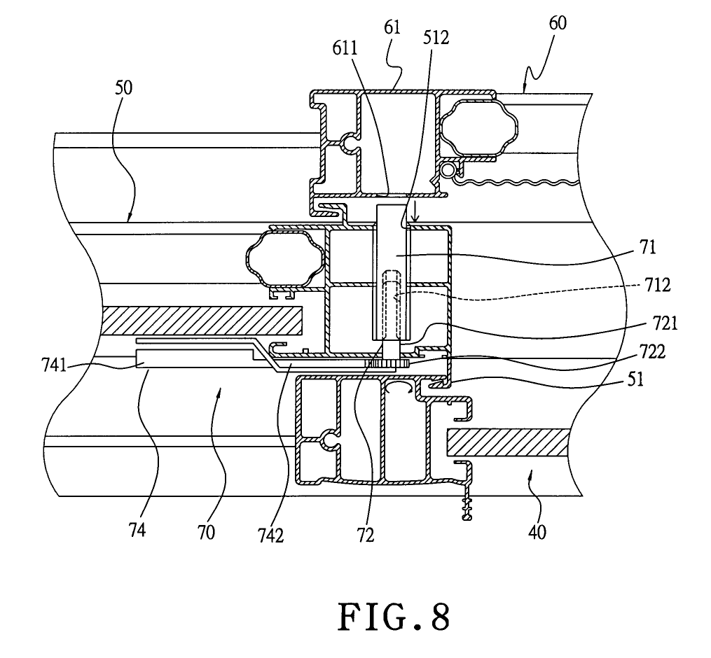

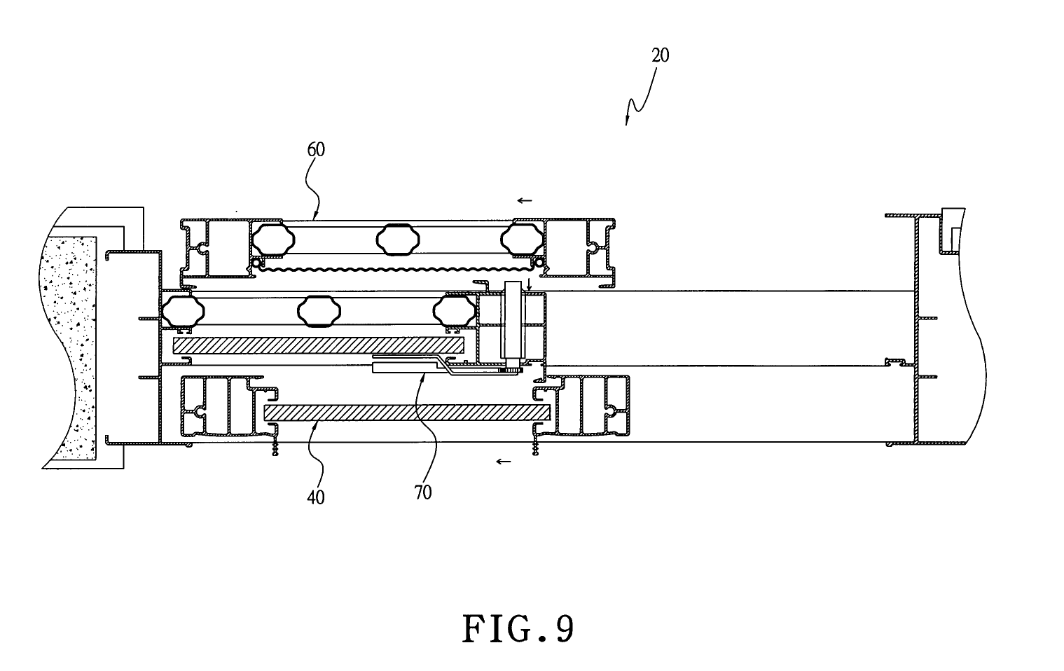

In order to further understand the characteristics and operation of the invention, its using way is to be described as below.
(1) In locking the latch, as shown in FIGS, 5 and 6, the anti-burglary net window body 60 and the inner window body 40 are orderly closed, and the pull rod member 741 of the swing plate 74 exposed out is swung down for a preset angle. Then the fan-shaped gear 742 engaging the gear 722 is rotated counterclockwise, so the helical rod member 721 of the helical member 72 moves to engage the helical hole 712 of the latch body 71, forcing the latch body 71 shift outward and move into the latch hole 611 of the anti-burglary net window body 60, attaining the effect of locking the anti-burglary net window body 60. As the swing plate 74 has its pull rod member 741 stopped by the lower projecting point 739 on the protective plate 73 , the swing plate 74 can be secured stably at its place and also hidden by the protective plate 73 so that a burglar cannot extend the hand into to catch and swing the pull rod member 741 of the swing plate 74 after cutting the glass near the swing plate 74. Thus the anti-burglary net window body 60 is completely protected from being pried open.
(2) In opening, as shown in FIGS. 7 and 8, if the inner window body 40 is opened for air to ventilate, the inner window body 40 is be at first closed, and the pull rod member 741 of the latch 70 exposed outside must be swung up for a preset angle to let the fan-shaped gear 742 engage and rotate the gear 722 clockwise, and further let the helical rod member 721 of the helical member 72 engage and rotate in the helical hole 712 of the latch body 71 to force the latch body 71 shift inward further away from the latch hole 611 of the anti-burglary net window body 60, finishing opening of the anti-burglary net window body 60 with quickness. As the swing plate 74 has the pull rod member 741 is stopped by the upper projecting point 739, keeping the swing plate 74 secured in place stably and from falling down. In case the anti-burglary net window body 60 should be opened for emergency, the inner window body 40 and the anti-burglary set window body 60 are orderly opened, as shown in FIG. 9, for persons inside to make swift escape through the window.

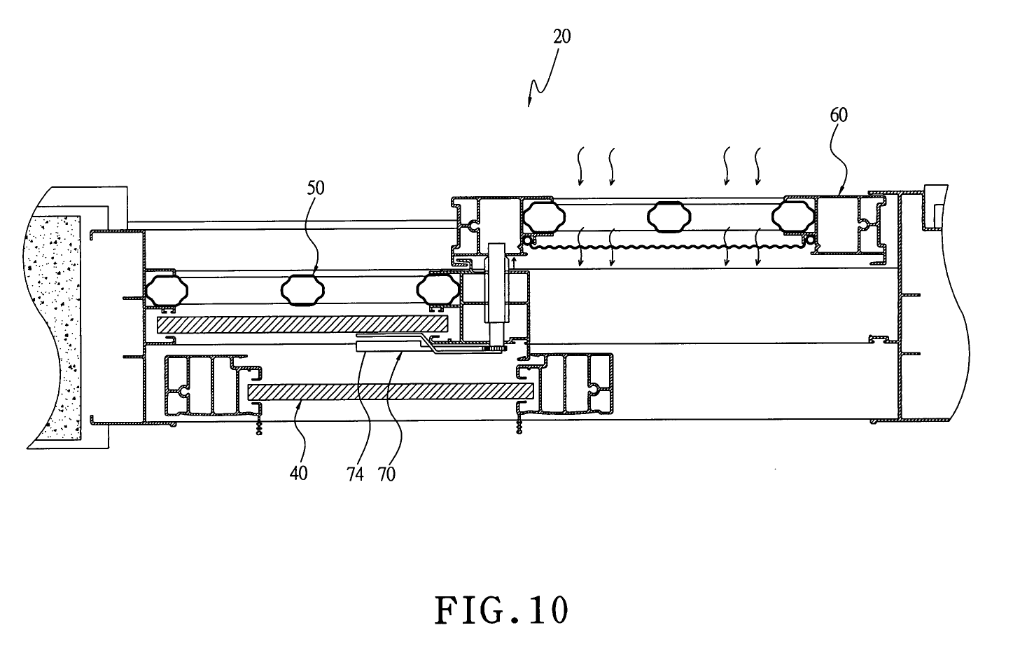

Next, as shown in FIG. 10, when the anti-burglary net window body 60 is in the closed condition, the swing plate 74 of the latch 70 is impossible to be tampered illegally from the outside, even if the inner window body 40 is opened, because the swing plate 74 is located between the inner and the outer window body 40 and 50. Therefore the anti-burglary net window body 60 is kept safe, never to be pried open by burglars or thieves.

While the preferred embodiment of the invention has been described above, it will be recognized and understood that various modifications may be made therein and the appended claims are intended to cover all such modifications that may fall within the spirit and scope of the invention.

1. A keyless latch for an anti-burglary window, said anti-burglary window combined in a sash frame, said sash frame provided with an inner window groove, an outer window groove and a net window groove from inside to outside orderly, a slidable switch provided on an inner window body of said anti-burglary window, a switch fixed on an outer window body of said anti-burglary window, a slidable switch provided on said anti-burglary net window body, said anti-burglary net window body located at a different side from said outer window body and surrounded by a frame and consisting of a anti-burglary layer and a net fitted in the frame:
Said outer window body having a middle post, said middle post having a hole through its outer wall:
Said anti-burglary net window body having a latch hole in its frame abutting on said outer window body, said latch hole facing said hole of said outer window body:
Said latch comprising:
A latch body extending and limited to rotate in said hole of said outer window body and shifting inward and outward linearly for a preset distance, said latch body extending in said latch hole of said anti-burglary net window body in case of shifting outward, said latch body separating from said latch hole in case of shifting inward:
A helical member having its inner portion positioned and rotating in said hole of said outer window body and its outer portion engaging helically with said latch body, said helical member rotating in a preset direction in said latch body and shifting linearly outward and inward, said inner portion exposed out of said hole of said outer window body:
A protective plate fixed firmly with a preset section of said middle post of said outer window body:
A swing plate having its intermediate portion extending through said protective plate and its outer end portion formed with a pull rod member for swinging up and down said swing plate for a preset angle, said swing plate having its inner side engaging with said helical member for rotating said helical member for moving said latch body to lock or unlock said anti-burglary net window body.

2. The keyless latch for an anti-burglary window as claimed in claim 1, wherein said middle post of said outer window body further has a position groove respectively at two sides of said hole, said latch body has two position ridges symmetrically on an outer surface to fit in said position groove of said middle post for limiting rotation of said latch body in axial shifting.

3. The keyless latch for an anti-burglary window as claimed in claim 1, wherein said latch body and said helical member respectively have a helical hole and a helical rod member to engage with each other.

4. The keyless latch for an anti-burglary window as claimed in claim 1, wherein said helical member has a gear fixed at the inner end, said swing plate has a fan-shaped gear at the inner end, and said fan-shaped gear engaging with said gear of said helical member, with the total teeth number of said fan-shaped gear being about two times as that of said gear.

5. The keyless latch for an anti-burglary window as claimed in claim 1, wherein said protective plate has a pivotal plate member formed in its right side portion and a stop plate portion formed in its left side portion, said pivotal plate member is a little higher that said stop plate member to define a ramp between them, said ram having an elongate slot of a preset length, said pivotal plate member having plural holes spaced apart around near its outer edge for bolts to screw therein and further engage with the inner wall of said middle post of said outer window body so that the inner wall of said pivotal plate member properly limiting said helical member, said stop plate member having a projecting point respectively on its upper and its lower surface for stopping said swing plate in swinging down and up, said stop plate member having a size hiding the swinging area of said swing plate.
